(19) United States
(12) Patent Application Publication
(10) Pub. No.: US 2006/0204627 A1
(43) Pub. Date: Sep. 14, 2006

(54) Stuffed strawberries

(76) Inventor: Susan E. Eminger, Auburn, ME (US)

Correspondence Address: Susan E. Eminger, 26 Vernon Street, Auburn, ME, 04210, US

(21) Appl. No.: 11/074,169

(22) Filed: Mar. 8, 2005

(51) Int. Cl. A23P 1/00

(52) U.S. Cl. 426/518

(57) ABSTRACT

Removing the center of a strawberry with the intent to stuff it is new. Stuffing a strawberry is new. Dipping a strawberry in chocolate is not new.

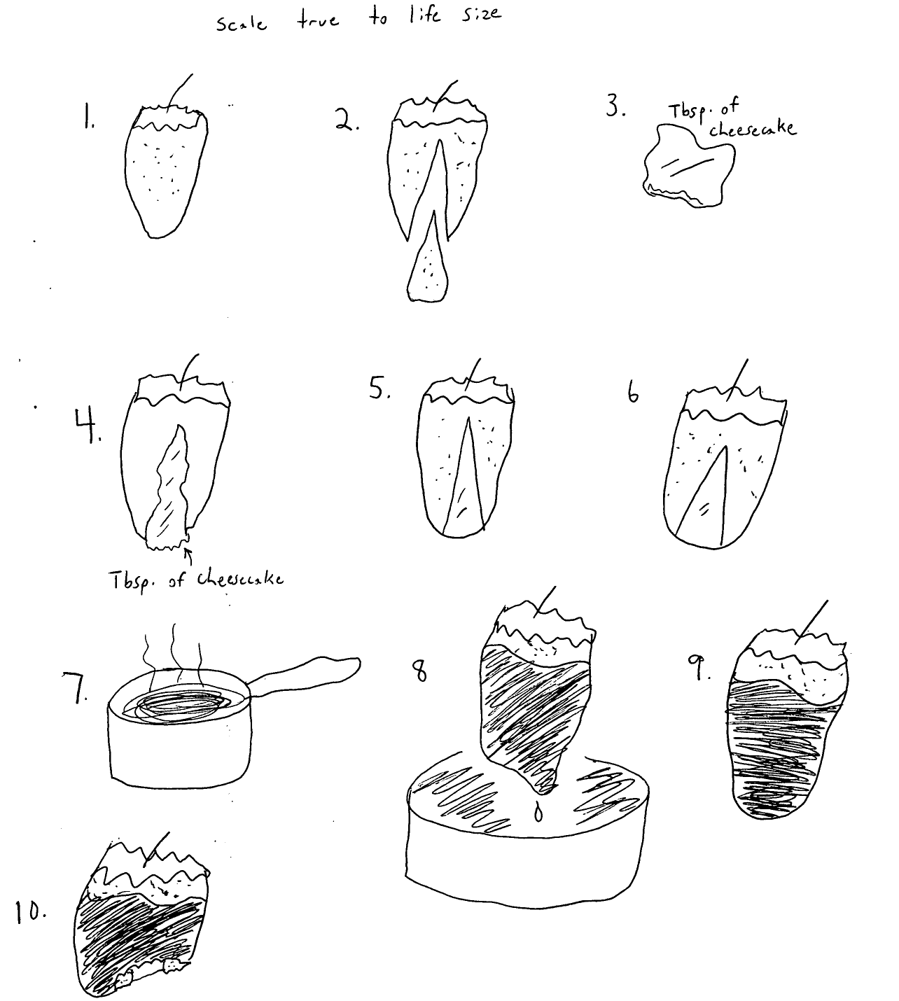

The invention is the stuffing of strawberries with any type of food substance. This is done by removing a central wedge from the berry first. I do this with a pairing knife. Once the strawberry has, the center removed, I can add whatever filling I like to that empty space. An example of a filling would be cheesecake. Using my fingers, I smooth the filling to match the appearance of the original unstuffed strawberry. Then I dip the berry in something such as chocolate. This creates the illusion that the product is simply a chocolate dipped strawberry. In reality, it has a surprise dessert center. As a result of this patent, no strawberry will be allowed to have a surprise center, accept for mine.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to food service. As a chef, I have created this invention.

### BRIEF SUMMARY OF THE INVENTION

Stuffed Strawberries are my invention. Chocolate covered strawberries have been around for a long time. I watched a lady on Valentine's Day say “Chocolate covered strawberries . . . It doesn't get any better than that!” Well, I say it does. I have invented strawberries that are first stuffed with dessert (cheesecake, custard, cookie dough, ect.), then dipped in chocolate. The result is a whole new dessert experience. My Stuffed strawberries will be one of a kind.

### BRIEF DESCRIPTION OF THE SEVERAL VIEWS OF THE DRAWING

1. This is a plain strawberry.

2. This is the center of the strawberry being taken out.

3. This is the filling.

4. This is the filling being put in the center of the strawberry.

5. This is the smoothed filled strawberry.

6. This is the chilling of the filled strawberry. This allows filling to set.

7. This is melted chocolate.

8. This is the dipping of the stuffed strawberry in chocolate.

9. This is the end result.

10. This is the end result with a bite taken out of it.

### DETAILED DESCRIPTION OF THE INVENTION

Picked Strawberries are washed and dried completely. Using a knife, I cut from the upper middle of the strawberry, just below the green top. Cut at an angle, downward to the left. Go back to the upper middle. This time, cut downward to the right. What you have done is cut out a triangle shaped piece of strawberry. Remove it to reveal an empty space. Discard the cut out piece of strawberry. Take any filling you like and put it in the space. I choose fillings that are soft enough to squish in that center, yet firm enough to set up and give a solid appearance. I then chill the stuffed strawberries. Once chilled, I smooth the surface of the filling to match that of the strawberry (like plastering a whole in the wall). I then dip the stuffed strawberry in chocolate. It looks like any other chocolate covered strawberry. But once you bite in, the difference is clear. It is a unique food item with a surprise center.

1. What I claim as my invention are strawberries stuffed with any type of food product.
